(19) United States
(12) Patent Application Publication
(10) Pub. No.: US 2020/0184545 A1
(43) Pub. Date: Jun. 11, 2020

(54) MULTI-VENDOR CROSS-PLATFORM SYSTEMS AND METHODS FOR IMPLEMENTING CROSS-PLATFORM INTERACTIVE GUIDED INTERFACES (GUIs)

(71) Applicant: Zebra Technologies Corporation, Lincolnshire, IL (US)

(72) Inventors: Edward Barkan, Miller Place, NY (US); Darran Michael Handshaw, Sound Beach, NY (US); Mark Drzymala, Saint James, NY (US)

(21) Appl. No.: 16/210,744

(22) Filed: Dec. 5, 2018

(51) Int. Cl. G06Q 30/06; G06K 7/14; H04L 29/06; G06K 19/06

(52) U.S. Cl. CPC G06Q 30/0641; G06K 7/1417; G06F 3/0482; G06K 19/06037; H04L 63/083

(57) ABSTRACT

A universal multi-vendor cross-platform is described for implementing cross-platform interactive guided user interfaces (GUIs). A multi-vendor server is configured to receive respective first and second user interfaces and vendor information from remote, communicatively coupled first and second vendor platforms associated with respective first and second vendors, each having physical vendor locations. A cross-platform mobile application (app) implements a cross-platform interactive GUI on a mobile device and is configured to (1) determine a current location or location setting of the mobile device, and (2) determine that the current location or location setting of the mobile device is at, near, or associated with one of the first or second physical vendor locations. Based on a determination of the current location or location setting, the cross-platform mobile app receives and renders a cross-platform interactive GUI that includes the user interfaces and information of one of the first vendor or the second vendor, respectively.

### BACKGROUND OF THE INVENTION

Vendors typically rely on stand-alone mobile applications (apps), e.g., vendor-specific apps, which are unique to a specific vendor's retail location(s). Such vendor-specific apps must be downloaded by end users, where such end users are generally required to supply redundant information across each app in order to enroll in or otherwise utilize each vendor-specific app for each store that a user visits or otherwise shops in. In addition, various vendor-specific apps generally have different features, different functionality, different layouts, and/or degrees of information supplied by the various respective vendors, all of which contribute to the learning curve experienced by users for each vendor-specific app downloaded.

Accordingly, because of such problems and disadvantages, users typically are routinely discouraged from downloading and using multiple vendor-specific apps, and, thus knowing, or unknowingly, forgo vendor specific benefits provided via such apps.

Accordingly, there is a need for a universal multi-vendor cross-platform system, and related methods, for implementing cross-platform interactive guided user interfaces (GUIs) to alleviate such issues.

In addition, there is a further need for systems and methods regarding a universal multi-vendor cross-platform system for multi-vendor competitive analysis to provide additional benefits as describe herein.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view, as seen from above, of a retail venue having detector stations, in accordance with example embodiments herein.

FIG. 2 is a block diagram representative of an embodiment of a centralized controller of FIG. 1, in accordance with various embodiments disclosed herein.

FIG. 3 is a block diagram illustrating an example implementation of a detector station, including several detectors, as may be used in the retail venue of FIG. 1, in accordance with various embodiments disclosed herein.

FIG. 4 is a system diagram depicting an example universal multi-vendor cross-platform system for implementing cross-platform interactive guided user interfaces (GUIs), in accordance with various embodiments disclosed herein.

FIG. 5A illustrates an example mobile device implementing a first embodiment of a cross-platform interactive GUI, in accordance with various embodiments disclosed herein.

FIG. 5B illustrates an example mobile device implementing a second embodiment of a cross-platform interactive GUI, in accordance with various embodiments disclosed herein.

FIG. 6 is a flow chart of an example universal multi-vendor cross-platform method for implementing cross-platform interactive GUIs, in accordance with various embodiments disclosed herein.

FIG. 7 is a flow chart of an example universal multi-vendor cross-platform method for multi-vendor competitive analysis, in accordance with various embodiments disclosed herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

As described herein, universal multi-vendor cross-platform systems and methods are disclosed for implementing cross-platform interactive GUIs and for implementing multi-vendor competitive analysis. Such systems and methods enable end users to sign up once to gain access to multiple vendors/retailers through a single mobile app (i.e., a cross-platform mobile app) as describe herein.

As described in various embodiments herein, a cross-platform mobile app provides a single app that end users may download and which allows frictionless shopping at numerous vendors. Such cross-platform mobile app provides an alternative to signing up or downloading vendor specific apps typically required for each vendor. In various embodiments, the cross-platform mobile app, and related systems, such as multi-vendor server(s), etc., may be supported as a service from a single provider. In addition, the cross-platform mobile app provides a plethora of benefits over isolated, vendor-specific apps. For example, the cross-platform mobile app of the disclosed embodiments may provide a centralized payment system that can support product scanning, e.g., either via pairing with a hand-held scanner, that may be provided at a vendor specific location, or via an end user mobile device camera. Each of these embodiments may allow scanning and checkout in any stores that use and/or subscribe to the universal multi-vendor cross-platform systems and methods as describe herein. For example, in some embodiments, a vendor may use hardware (e.g., hand-held scanners) and services provided for the universal multi-vendor cross-platform system. In other embodiments, vendors may pay for just the service itself, and rely on end user mobile device hardware or other hardware. In any event, an end user may download the cross-platform mobile app to his or her mobile device (e.g., mobile phone) and would be able to use cross-platform mobile app with any vendor that uses the related universal multi-vendor cross-platform service.

The universal multi-vendor cross-platform systems and methods provide several advantages (e.g., compared with vendor-specific apps). For example, such benefits include that the cross-platform mobile app, through the multi-vendor cross-platform system, provides users with a universal app to use at their favorite vendors, which may allow for a frictionless (e.g., less time consuming and burdensome) shopping and checkout experience. For example, the cross-platform mobile app, may recommend the most convenient and/or cheapest vendors to fulfill current shopping needs, e.g., as determined by a pre-determined list as described herein. For example, a pre-determined list, or “centralized shopper list,” described herein may provide both a convenience for an end user, and an opportunity for a vendor, to track and incentive customers by sending offers to users who make known products or items that they expect to purchase. In some embodiments, such centralized shopper lists may be based on, e.g., a user's proximity to a physical vendor location and/or providing offers that result in lower prices. Many of the advantages may also drive vendor adoption as more vendors and/or users join, and others seek to join to share in the benefits. For example, the cross-platform mobile app, through the multi-vendor cross-platform system, may drive adoption by vendors desiring to gain users that use the app.

Additional benefits include that a vendor may receive and/or review user and/or purchasing data as generated by the universal multi-vendor cross-platform system, which may assist vendors with marketing promotions, decisions, etc. Such decisions may include, e.g., allowing vendors to generate coupons, special offers, etc. to users or otherwise entice users to visit specific physical vendor locations.

Further benefits include improved security and customer service through customer tracking via the cross-platform mobile app, generation of competitive sales data in categories of specific products (e.g., that may be used by vendors for target marketing), and the ability of an end user to have a third-party shop on the end user's behalf and/or have products delivered it to an end user's address. In addition, the cross-platform mobile app may allow users to review vendor specific locations and submit feedback, allowing for continuous improvement. For example, a user may provide negative feedback that a vendor may use to improve its physical vendor store, etc.

Accordingly, as described herein, several embodiments of the present disclosure describe universal multi-vendor cross-platform systems and methods for implementing cross-platform interactive guided user interfaces (GUIs). The universal multi-vendor cross-platform systems and methods may include a multi-vendor server communicatively coupled, via a computer network, to a first vendor platform of a first vendor and a second vendor platform of a second vendor. Each of the first vendor platform and the second vendor platform may be remote to the multi-vendor server.

In various embodiments, the multi-vendor server may be configured to receive a first set of user interfaces and a first set of vendor information associated with the first vendor platform. Similarly, the multi-vendor server may be configured to receive a second set of user interfaces and a second set of vendor information associated with the second vendor platform. The first vendor may be associated with one or more first physical vendor location(s) and the second vendor may be associated with one or more second physical vendor location(s).

The universal multi-vendor cross-platform systems and methods may further include a cross-platform mobile app implementing a cross-platform interactive GUI on a mobile device associated with a user. The mobile device may comprise a data capture assembly. In various embodiments, the cross-platform mobile app may be communicatively coupled to the multi-vendor server via the computer network. The cross-platform mobile app may be configured to execute instructions, via one or more processors of the mobile device, to determine a current location or location setting of the mobile device. The cross-platform mobile app may further be configured to execute instructions to determine that the current location or location setting of the mobile device is at, near, or associated with one of: (i) the first physical vendor location or (ii) the second physical vendor location.

In various embodiments, based on a determination of the current location or location setting being at, near, or associated with the first physical vendor location, the cross-platform mobile app may receive the first set of user interfaces and the first set of vendor information. In such embodiments, the cross-platform mobile app may render, via a display of the mobile device, a cross-platform interactive GUI using the first set of user interfaces and the first set of vendor information.

Alternatively, in various embodiments, based on a determination of the current location or location setting being at, near, or associated with the second physical vendor location, the cross-platform mobile app may receive the second set of user interfaces and the second set of vendor information. In such embodiments, the cross-platform mobile app may render, via the display of the mobile device, a cross-platform interactive GUI using the second set of user interfaces and the second set of vendor information.

In additional various embodiments, the universal multi-vendor cross-platform system, and related methods, may be used to perform multi-vendor competitive analysis. In such embodiments, a multi-vendor server may be communicatively coupled, via a computer network, to a first vendor platform of a first vendor and a second vendor platform of a second vendor. Each of the first vendor platform and the second vendor platform may be remote to the multi-vendor server.

The multi-vendor server may be configured to receive a first set of user interfaces and a first set of vendor information from the first vendor platform. Similarly, the multi-vendor server may be configured to receive a second set of user interfaces and a second set of vendor information from the second vendor platform. The first vendor may be associated with one or more first physical vendor location(s) and the second vendor may be associated with one or more second physical vendor location(s).

The universal multi-vendor cross-platform system, and related methods, may be associated with a plurality of instances of a cross-platform mobile apps implementing respective cross-platform interactive GUIs. In such embodiments, the plurality of instances may be configured to execute on a plurality of mobile devices associated with a plurality of users. The plurality of instances may further each be communicatively coupled to the multi-vendor server via the computer network. In various embodiments, each of the plurality of instances may be configured to execute instructions, via one or more processors of a corresponding mobile device of the plurality of mobile devices, to render, via a display of the corresponding mobile device, a cross-platform interactive GUI, the cross-platform interactive GUI rendered using either (i) the first set of user interfaces and the first set of vendor information or (ii) the second set of user interfaces and the second set of vendor information.

In various embodiments, each of the plurality of instances may transmit, to the multi-vendor server, user tracking information. In such embodiments, the user tracking information may be defined as associated with either (i) the first vendor when the cross-platform interactive GUI is rendered with the first set of user interfaces and the first set of vendor information, or (ii) the second vendor when the cross-platform interactive GUI is rendered with the second set of user interfaces and the second set of vendor information.

In still further embodiments, the multi-vendor server may be configured to transmit to the first vendor platform and the second vendor platform, one or more cross-platform metrics determined from the user tracking information.

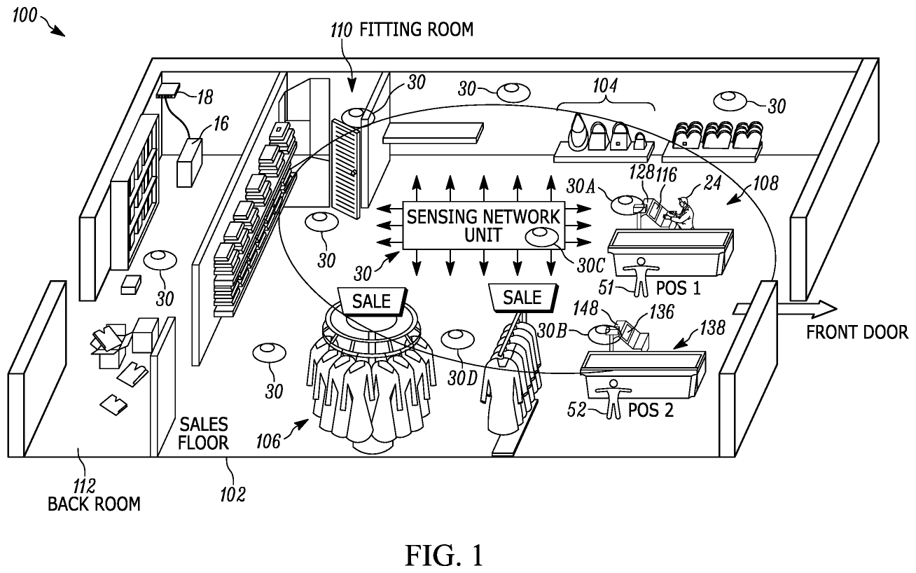

Such embodiments will be further described herein with respect to FIGS. 1-7, which illustrate example disclosure of universal multi-vendor cross-platform systems and methods.

FIG. 1 is a perspective view, as seen from above, of a retail venue 100 having detector stations 30, in accordance with example embodiments herein. Retail venue 100 is representative of physical vendor locations, e.g., first and/or second physical vendor locations, as described herein for various embodiments associated with universal multi-vendor cross-platform systems and related methods.

In the example embodiment of FIG. 1, retail venue 100 includes a backroom 112 that has a centralized controller 16. The retail venue also includes a fitting room 110, and a retail sales floor 102 with various retail items (e.g., 104 and 106), and two POS stations (108 and 138) that each have respective POS lanes (POS lane 1 and POS lane 2). Each of the POS stations (108 and 138) may include various types of equipment. For example, POS station 108 may include a computer system 116 and an interface 128 that may include, for example, an optical scanner, touchpad, keypad, display, and data input/output interface connecting to the computer system 116. The computer system 116 may be operated by store personnel 24, which may be, for example, an employee, contract worker, owner, or other operator or store personnel of the retail store. POS station 138 may similarly include a computer system 136 and an interface 148 that may include, for example, an optical scanner, touchpad, keypad, display, and data input/output interface connecting to the computer system 136. POS station 138 is not operated by store personnel and, therefore, at least in some embodiments may represent a closed, inactive, or otherwise empty POS lane or station.

Each of the POS stations 108 and 138 has related POS lanes, which include POS lane 1 and POS lane 2, respectively. Individuals, such as customers, store personnel, or other individuals, may reside in, move through, or otherwise occupy the POS lanes at various times. Such individuals may be carrying, or associated with (e.g., pushing a shopping cart, etc.) one or more related products (e.g., products 104 or 106) or other store merchandise. For example, one or more individual(s) 51 may occupy POS lane 1, where individual(s) 51 may represent customers at POS station 108 checking out, standing in line, and/or interacting with store personnel 24.

As another example, one or more individual(s) 52 may occupy or move through POS lane 2, where individual(s) 52 may represent customers moving through POS lane 2, for example, either entering or exiting the venue 100, or checking out with POS station 138, or otherwise interacting with POS station 138. For example, in some embodiments, POS station 138 may be an automated station, where computer system 136 is configured to scan consumer products and accept payment from customers for products that the consumers bring to POS station 138 and POS lane 2.

Venue 100 further includes the centralized controller 16 which may comprise a networked host computer or server. The centralized controller 16 may be connected to one or more detector station(s) 30 positioned throughout the venue 100 via the network switch 18. As further described herein, the detector stations 30 are able to detect targets including, for example, people or users, such as store personnel 24 or consumers within the store (not shown), as well as the various retail products or items being offered for sale on the floor 102, e.g., clothes 106, handbags 104, etc., that are arranged on shelves, hangers, racks, etc. In addition, each such product may be tagged with a RFID tag for detection as described herein, where consumers carrying the products can be tracked via RFID readers.

Each of the computer systems 116 and 136 may comprise one or more processors and may be in electronic communication with centralized controller 16 via the network switch 18. The network switch 18 may be configured to operate via wired, wireless, direct, or networked communication with one or more of the detector stations 30, where the detector stations 30 may transmit and receive wired or wireless electronic communication to and from the network switch 18. The detector stations may also be in wired and/or wireless communication with computer systems 116 and 136. Similarly, each of the detector stations 30 may either be in either wired or wireless electronic communication with centralized controller 16 via the network switch 18. For example, in some embodiments, the detector stations 30 may be connected via Category 5 or 6 cables and use the Ethernet standard for wired communications. In other embodiments, the detector stations 30 may be connected wirelessly, using built-in wireless transceivers, and may use the IEEE 802.11 (WiFi) and/or Bluetooth standards for wireless communications. Other embodiments may include detector stations 30 that use a combination of wired and wireless communication.

The interfaces 128 and 148 may provide a human/machine interface, e.g., graphical users interface (GUI) or screen, which presents information in pictorial and/or textual form (e.g., representations of bearings of the RFID-tagged products 104, 106). Such information may be presented to the store personnel 24, or to other store personnel such as security personnel (not shown). The computer systems (116, 136) and the interfaces (128, 148) may be separate hardware devices and include, for example, a computer, a monitor, a keyboard, a mouse, a printer, and various other hardware peripherals, or may be integrated into a single hardware device, such as a mobile smartphone, or a portable tablet, or a laptop computer. Furthermore, the interfaces (128, 148) may be in a smartphone, or tablet, etc. (not shown), while the computer systems (116, 136) may be a local computer, or a remotely hosted in a cloud computer. The computer systems (116, 136) may include a wireless RF transceiver that communicates with each detectors station 30, for example, via Wi-Fi or Bluetooth.

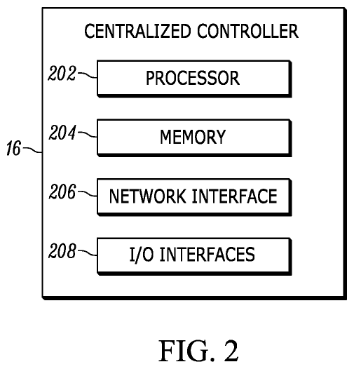

FIG. 2 is a block diagram representative of an embodiment of centralized controller 16 of FIG. 1. The centralized controller 16 is configured to execute computer instructions to perform operations associated with the systems and methods as described herein, for example, implement the example operations represented by the block diagrams or flowcharts of the drawings accompanying this description. The centralized controller 16 may implement enterprise service software that may include, for example, Restful (representational state transfer) API services, message queuing service, and event services that may be provided by various platforms or specifications, such as the J2EE specification implemented by any one of the Oracle WebLogic Server platform, the JBoss platform, or the IBM Web Sphere platform, etc. As described below, the centralized controller 16 may be specifically configured for performing operations represented by the block diagrams or flowcharts of the drawings described herein.

The example centralized controller 16 of FIG. 2 includes a processor 202, such as, for example, one or more microprocessors, controllers, and/or any suitable type of processor. The example centralized controller 16 of FIG. 2 further includes memory (e.g., volatile memory or non-volatile memory) 204 accessible by the processor 202, for example, via a memory controller (not shown). The example processor 202 interacts with the memory 204 to obtain, for example, machine-readable instructions stored in the memory 204 corresponding to, for example, the operations represented by the flowcharts of this disclosure. Additionally or alternatively, machine-readable instructions corresponding to the example operations of the block diagrams or flowcharts may be stored on one or more removable media (e.g., a compact disc, a digital versatile disc, removable flash memory, etc.), or over a remote connection, such as the Internet or a cloud-based connection, that may be coupled to the centralized controller 16 to provide access to the machine-readable instructions stored thereon.

The example centralized controller 16 of FIG. 2 may further include a network interface 206 to enable communication with other machines via, for example, one or more computer networks, such as a local area network (LAN) or a wide area network (WAN), e.g., the Internet. The example network interface 206 may include any suitable type of communication interface(s) (e.g., wired and/or wireless interfaces) configured to operate in accordance with any suitable protocol(s), e.g., Ethernet for wired communications and/or IEEE 802.11 for wireless communications.

The example centralized controller 16 of FIG. 2 includes input/output (I/O) interfaces 208 to enable receipt of user input and communication of output data to the user, which may include, for example, any number of keyboards, mice, USB drives, optical drives, screens, touchscreens, etc.

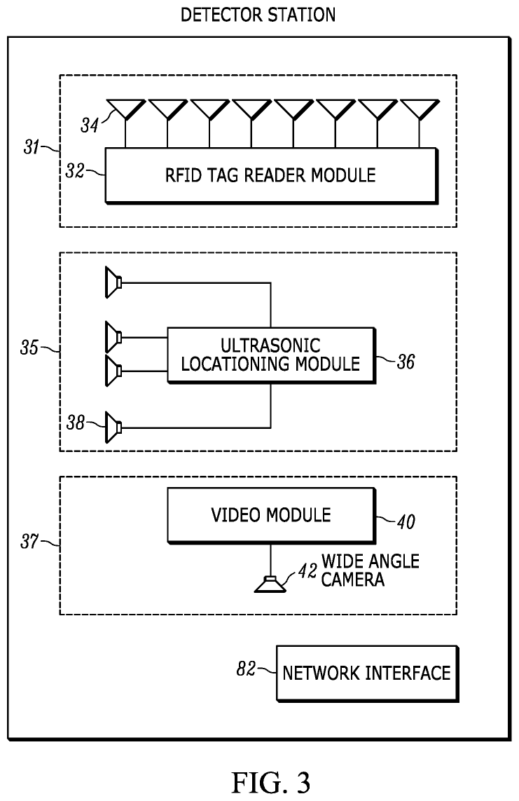

FIG. 3 is a block diagram illustrating an example implementation of an embodiment of a detector station 30 as illustrated and described for FIG. 1. In the illustrated example, the detector station 30 includes three example detectors 31, 35, and 37, as further described herein. For example, a detector in the form of a RFID tag reader 31 is operative for reading a target (e.g., a RFID tag associated with a product or person). In one embodiment, for example, an RFID tag attached to product resting on a shelf may be read and detected by its attached RFID tag. Similarly, an RFID tag associated with a product that a person has picked up may be detected and tracked as the person moves through the venue 100.

More particularly, as shown in FIG. 3, each RFID reader 31 includes an RFID tag reader module 32 that has a controller, a memory, and an RF transceiver, which are operatively connected to a plurality of RFID antenna elements 34, which are energized by the RFID module 32 to radiate RF energy (also referred to herein as a beam) over an antenna beam pattern. As those of skill will recognize, an antenna and its beam pattern can be characterized by the antenna's beam width (i.e., the antenna's half power beam width). The RF reader 31 is operated, under the control of the tag reader module 32, to transmit RF beam or wave energy to the tags, and to receive RF response signals from the tags, thereby interrogating and processing the payloads of the tags that are in a reading zone of the RF transceiver. The RFID reading zone for a detector station 30 may be a 360 degree zone defined by the RFID antenna elements 34 and their collective beam patterns. In various embodiments, a detector 30 may include eight RFID antenna elements 34, each maintained in a fixed position and each having a beam pattern extending in a different direction. During operation, the RF transceiver may capture payload data or target data that identifies the tags and their associated products (e.g., retail items 104 and/or 106). The centralized controller 16 may be configured to control the overhead RFID readers in the plurality of detector stations 30 to read the tags on the products (e.g., retail items 104 and/or 106) in a reading mode of operation in accordance with a set of reading parameters.

Referring to FIGS. 1 and 3, store personnel 24 may hold, carry, and operate any mobile device such as, a mobile phone, or as illustrated by way of non-limiting example, a handheld, portable, mobile RFID tag reader 22 (not shown) during his/her movement within the venue 100. As described below, the store personnel 24 himself/herself and/or the tag reader 22, may each be considered, either individually or jointly, as a mobile target to be located and tracked in the venue. The mobile reader 22 has a controller, a memory, and an RF transceiver operatively connected to an RFID antenna (e.g., RFID antenna 34), which are together operative for reading the product tags associated with products (e.g., 104 and/or 106) in the venue 100. The store personnel 24 may be any individual, employee, operator, or associate authorized to operate the handheld, mobile reader 22. In some embodiments, to initiate reading, the store personnel 24 may actuate an actuator or trigger on the mobile reader 22. More than one mobile reader 22 may be present and/or movable in the venue 100 at a time.

In other embodiments, a detector station 30 (as shown in FIG. 3) may be a Point-of-Sale (PoS) detector station. A POS detector station may include a central RFID reader with multiple remotely positioned RFID antennas local to the individual PoS read zones. For example, with reference to FIG. 1, a POS detector station may relate to POS station 108 and POS lane 1, where the POS detector station includes RFID attennas of detector 30A and/or other RFID attennas local to the POS read zone of POS station 108 and POS lane 1. In some embodiments, a video camera may be used in conjunction with the RFID reader attennas of the POS detector station. In particular embodiments, the video camera may be integrated with an RFID reader (e.g., a video camera 42 of detector station 30A), but in other embodiments the video camera may not be integrated with the RFID reader (e.g., a video camera is located separately from detector station 30A, but still captures images of the POS read zone of POS station 108 and POS lane 1).

Each detector station 30 may include another sensing detector, as shown in FIG. 3. For example, an ultrasonic locationing detector 35 may be operative for locating, for example, a phone, a mobile device, or by way of non-limiting example, the mobile reader 22, by transmitting an ultrasonic signal to an ultrasonic receiver, e.g., a microphone, on the mobile reader 22 or phone. More particularly, the locationing detector 35 includes an ultrasonic locationing module 36 having control and processing electronics operatively connected to a plurality of ultrasonic transmitters, such as voice coil or piezoelectric speakers 38, for transmitting ultrasonic energy to the microphone on the mobile reader 22. The receipt of the ultrasonic energy at the microphone locates the mobile reader 22. Each ultrasonic speaker 38 periodically transmits ultrasonic ranging signals, preferably in short bursts or ultrasonic pulses, which are received by the microphone on the mobile reader 22. The microphone determines when the ultrasonic ranging signals are received. The locationing module 36, under the control of the centralized controller 16, directs all the speakers 38 to emit the ultrasonic ranging signals such that the microphone on the mobile reader 22 will receive minimized overlapping ranging signals from the different speakers 38. The flight time difference between the transmit time that each ranging signal is transmitted and the receive time that each ranging signal is received, together with the known speed of each ranging signal, as well as the known and fixed locations and positions of the speakers 38 on each detector station 30, are all used to determine the location (i.e., position) and/or direction of travel of the microphone and of the mobile reader 22, using a suitable locationing technique, such as triangulation, trilateration, multilateration, etc. Such locationing and direction of travel may be determined by analyzing data from multiple detector stations 30 and centralized controller 16. In some embodiments, some detectors may be configured to determine location, while other detectors may be configured to determine direction of travel.

In the illustrated example of FIG. 3, the detector station 30 may further include a video detector 37 operative for detecting or locating a target by capturing an image of the target in the venue 100, such as a person moving through venue 100 or an item sitting on a shelf of venue 100. More particularly, the video detector 37 may be mounted in each detector station 30 and may include a video module 40 having a camera controller that is connected to a camera 42, which may be, for example, a wide-angle field of view camera for capturing the image of a target. In some embodiments, the camera 42 may be a high-bandwidth, video camera, such as a moving picture expert group (MPEG) compression camera. In other embodiments, the camera may include wide-angle capabilities such that camera 42 would be able to capture images over a large area to produce a video stream of the images. As referred to herein, the image capture devices or video cameras (also referred to as image sensors herein) are configured to capture image data representative of the venue or an environment of the venue. Further, the image sensors described herein are example data capture devices, and example methods and apparatuses disclosed herein are applicable to any suitable type of data capture device(s). In various embodiments, the images or data from the images may be synchronized or fused with other data, such as RFID data, and used to further describe, via data, the venue or environment of the venue. Such synchronized or fused data may be used, for example, by the centralized controller 16, or other server(s) (e.g., cloud server), to make determinations or for other features as described herein.

As described, each of the detector stations 30 may collect locationing and direction of travel information from its one or more detectors, such as the RFID reader 31 and/or the ultrasonic detector 35. That information is correlated with the video detector 37 to capture and filter video images based on the location and/or direction of travel of the target, such as a product or person. In particular, a detector station 30 may filter captured video to segment out from the captured wide-angle video, images of the target near the target sensing station, as the target is moved through the venue. That segmenting may result in discarding video images that do not include the target or discarding portions of the wide-angle video that extend beyond an area of interest surrounding and including the target itself.

In various embodiments, focusing, image tilting, and image panning procedures may be determined by first performing image processing on the target in the wide-angle video stream. For example, in some embodiments, a detector station 30 may perform target identification procedures over the determined field of view, procedures such as edge detection to identify the target, segmentation to segment out the target's image from other objects in the video stream, and a determination of any translational, rotational, shearing, or other image artifacts affecting the target image and that would then be corrected for before using the captured target image.

Any of the detector stations 30, including alone, together, or some combination thereof, may transmit electronic information, including any RFID, ultrasonic, video, or other information, to the centralized controller 16 for processing. For example, the central controller 16 of FIG. 2 may include a network communication interface 206 communicatively coupled to network communication interfaces 82 of the detector stations 30 to receive sensing detector data, such as RFID information and/or ultrasonic locationing information, and video stream data, such as a video stream from the wide-angle camera 42. The detector stations 30 may also receive information, commands, or execution instructions, including requests to provide additional sensory or detection information from the centralized controller 16 in order to perform the features and functionally as described herein.

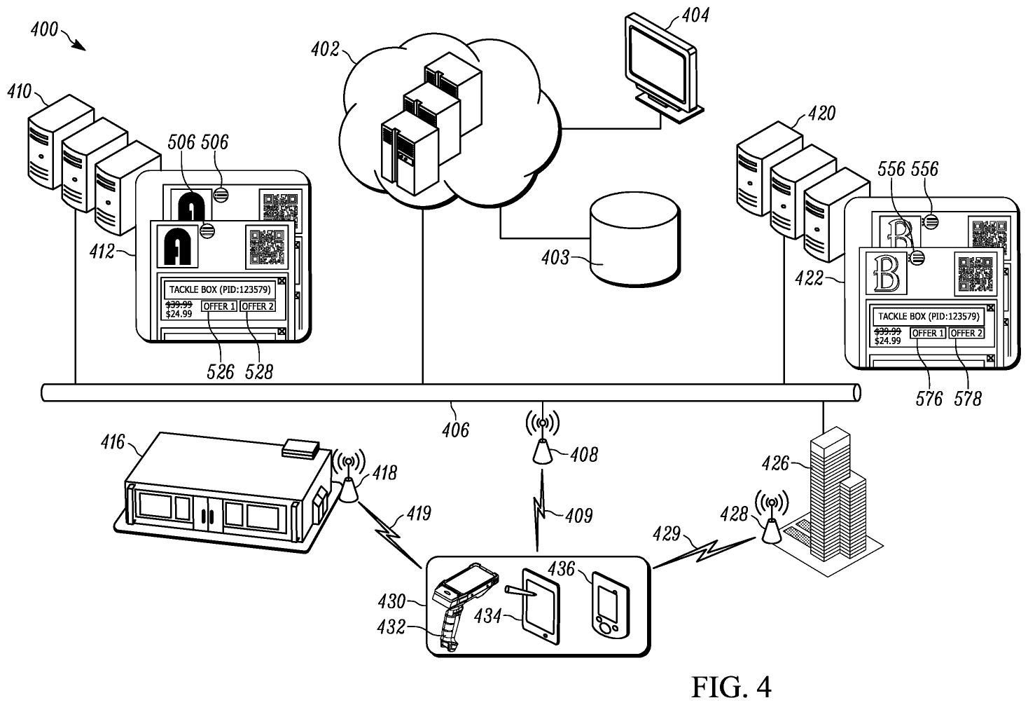

FIG. 4 is a system diagram 400 depicting an example universal multi-vendor cross-platform system for implementing cross-platform interactive GUIs, in accordance with various embodiments disclosed herein. Diagram 400 illustrates multiple vendor locations 416 and 426, where, in various embodiments, first physical vendor location 416 may be associated with a first vendor and second vendor location 426 may be associated with a separate, second vendor. In other embodiments, first physical vendor location 416 and second vendor location 426 may represent different physical vendor locations associated with the same vendor. In any event, it is to be understood that while only two vendor locations are shown, the disclosure herein contemplates multiples of physical vendor locations, whether the multiples of physical vendor locations may be operated or controlled by different vendors and/or a single vendor depending on the embodiment.

In various embodiments, venue 100 of FIG. 1 is representative first physical vendor location 416 and/or second vendor location 426. Accordingly, each of first physical vendor location 416 and/or second vendor location 426 include, e.g., a centralized controller (e.g., centralized controller 16 as described for FIG. 2) and one or more detector stations 30 (e.g., as described for FIG. 3).

In the embodiment of FIG. 4, each of first physical vendor location 416 and second vendor location 426 are connected, e.g., via their respective centralized controllers (e.g., respective centralized controllers 16) and via computer network 406, to a multi-vendor cross-platform cloud server 402. Computer network 406 may be a private or public network. For example, in various embodiments, computer network 406 may be the Internet.

Multi-vendor cross-platform cloud server 402 may include one or more servers and/or processors configured to transmit and receive data, information, user interfaces, or other such data as described in the various embodiments herein. In some embodiments, multi-vendor cross-platform cloud server 402 may be a rules driven and/or data driven server, where multi-vendor cross-platform cloud server 402 executes decisions and/or transmits data, information and/or user interfaces based on predetermined rules and/or data stored or determined from transactions or otherwise as described herein. Such data may be stored in related multi-vendor cross-platform database 403, which may be a local or remote database, or electronic storage facility, communicatively coupled to multi-vendor cross-platform cloud server 402. Multi-vendor cross-platform cloud server 402 may implement massive data or big data software or a framework (e.g., Apache Hadoop) to process data, information, and user interfaces, etc. that is received by vendors as described herein.

Multi-vendor cross-platform cloud server 402 may be comprised of one or more servers (e.g., a server farm) configured to execute computer instructions to perform operations associated with the systems and methods as described herein, for example, for implementing the example operations represented by the block diagrams or flowcharts of the drawings accompanying this description. In various embodiments, multi-vendor cross-platform cloud server 402 may be implemented as a remote cloud platform that implements Software as a Service (SaaS) or is otherwise configured as a platform as a service (PaaS) to generate and/or transmit the user interfaces, data, and information of vendors and/or vendor locations as described herein.

In some embodiments, for example, multi-vendor cross-platform cloud server 402 may implement enterprise service software that may include, for example, Restful API services, message queuing service, and event services that may be provided by various platforms or specifications, such as the J2EE specification implemented by any one of the Oracle WebLogic Server platform, the JBoss platform, or the IBM Web Sphere platform, etc.

Multi-vendor cross-platform cloud server 402 may include one or more processors, such as, for example, one or more microprocessors, controllers, and/or any suitable type of processor. Multi-vendor cross-platform cloud server 402 may further include memory (e.g., volatile memory or non-volatile memory) accessible by the processor(s), for example, via a memory controller. For example, the processors(s) may interact with the memory of the multi-vendor cross-platform cloud server 402 to obtain, for example, machine-readable instructions stored in the memory corresponding to, for example, the operations represented by the flowcharts of this disclosure. Additionally or alternatively, machine-readable instructions corresponding to the example operations of the block diagrams or flowcharts may be stored on one or more removable media (e.g., a compact disc, a digital versatile disc, removable flash memory, etc.), or over a remote connection, such as the Internet or a cloud-based connection, that may be coupled to multi-vendor cross-platform cloud server 402 to provide access to the machine-readable instructions stored thereon.

Multi-vendor cross-platform cloud server 402 may further include a network interface to enable communication with other machines via, for example, one or more computer networks, such as a local area network (LAN) or a wide area network (WAN), e.g., the Internet. The network interface of multi-vendor cross-platform cloud server 402 may include any suitable type of communication interface(s) (e.g., wired and/or wireless interfaces) configured to operate in accordance with any suitable protocol(s), e.g., Ethernet for wired communications and/or IEEE 802.11 for wireless communications.

Multi-vendor cross-platform cloud server 402 may include input/output (I/O) interfaces to enable receipt of user input and communication of output data to the user, which may include, for example, any number of keyboards, mice, USB drives, optical drives, screens, touchscreens, etc. For example, multi-vendor cross-platform cloud server 402 may allow administrative or local access via local computer 404.

In various embodiments herein, multi-vendor cross-platform cloud server 402 is communicatively coupled, via a computer network 406, to first vendor platform 410 of a first vendor and second vendor platform 420 of a second vendor. The first and second vendor(s) may be same entity or separate entities. In the embodiment of FIG. 4, each of first vendor platform 406 and second vendor platform 420 are remote to multi-vendor cross-platform cloud server 402.

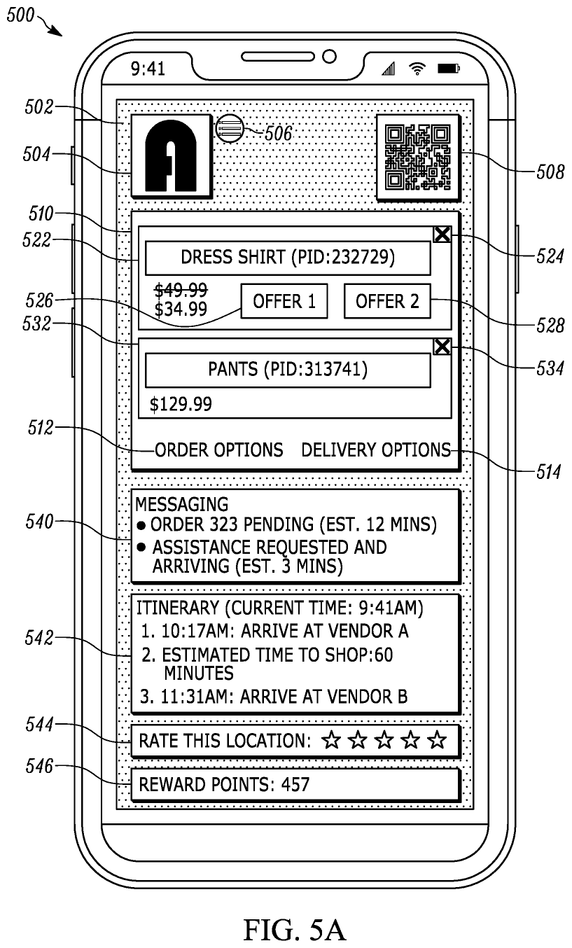

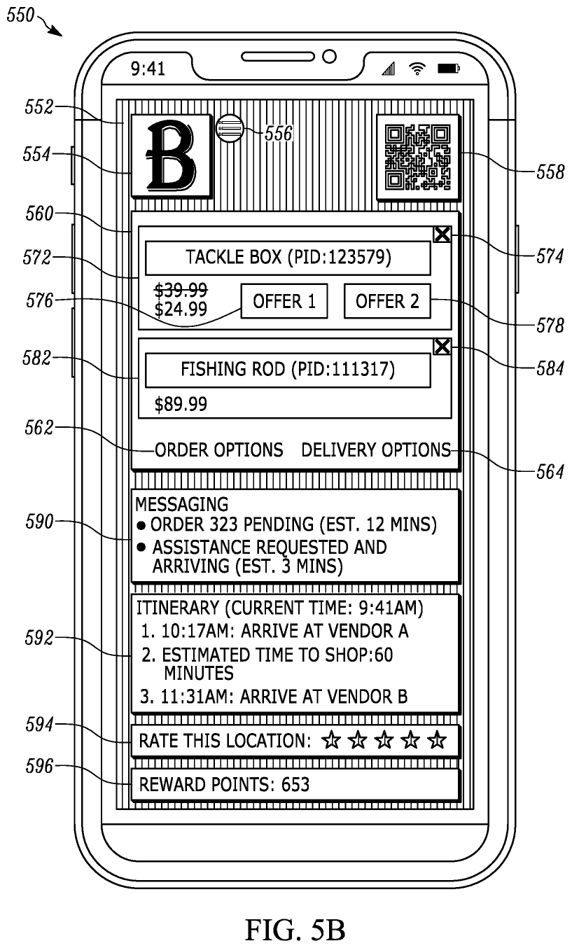

In various embodiments, multi-vendor cross-platform cloud server 402 is configured to receive a first set of user interfaces 412 and a first set of vendor information from first vendor platform 410. For example, first set of user interfaces 412 may be a set of user interfaces as illustrated and described herein for FIG. 5A. First vendor platform 410 may be implemented as one or more servers (including, e.g., one or more processors and memories) owned or controlled by the first vendor for purposes of generating, updating, and/or otherwise managing user interfaces and/or first vendor data for generating and/or rendering interactive GUIs of the first vendor as described herein. The user interfaces and/or first vendor data of the first vendor may be stored in or otherwise transmitted from first vendor platform 410. Additionally, or alternatively, first set of user interfaces 412 and first set of vendor information may be received from first physical vendor location 416 (e.g., from a centralized controller 16 of first physical vendor location 416).

Similarly, multi-vendor cross-platform cloud server 402 may is configured to receive a second set of user interfaces 422 and a second set of vendor information from the second vendor platform 420. For example, second set of user interfaces 422 may be a set of user interfaces as illustrated and described herein for FIG. 5B. The second vendor platform 420 may be implemented as one or more servers (including, e.g., one or more processors and memories) owned or controlled by the second vendor for purposes of generating, updating, and/or otherwise managing user interfaces and/or second vendor data for generating and/or rendering interactive GUIs of the second vendor as described herein. The user interfaces and/or second vendor data of the second vendor may be stored in or otherwise transmitted from second vendor platform 420. Additionally, or alternatively, second set of user interfaces 422 and second set of vendor information may be received from second physical vendor location 426 (e.g., from a centralized controller 16 of second physical vendor location 426).

As described herein, either of the first and/or second vendors may be associated with multiple vendor locations, of which first physical vendor location 416 and second physical vendor location 426 are examples.

In the embodiment of FIG. 4, multi-vendor cross-platform cloud server 402 is commutatively coupled to one or more mobile devices 430. Mobile devices 430 may be connected to multi-vendor cross-platform cloud server 402 via a variety of communication standards, protocols, and networks. For example, mobile devices 430 may be connected to multi-vendor cross-platform cloud server 402 where mobile devices 430 use wireless communication (419 and/or 429) to communicate with physical vendor location communication systems (418 and/or 428), which in turn communicate, via computer network 406, with multi-vendor cross-platform cloud server 402. Such wireless communications (e.g., 419 and/or 429) may be implemented via wireless 802.11 (WiFi) and/or Bluetooth communication standards and/or protocols. In addition, communication systems 418 and/or 428 may include centralized server(s) 16 and/or detector stations 30 as described for FIGS. 1-3.

Additionally, or alternatively, mobile devices 430 may communicate with multi-vendor cross-platform cloud server 402 via cellular or other mobile communication standards 409 (e.g., GSM, LTE, UMTS, etc.), for example, via base station 408 connected to computer network 406.

As illustrated in FIG. 4, mobile devices 430 may include, but are not limited to, shopper device 432, tablet 434, and/or smart phone 436. Mobile devices 430 may communicate via wireless communication (e.g., 419 and/or 429) and/or cellular communication (409), e.g., via computer network 406, with any of multi-vendor cross-platform cloud server 402, first vendor platform 410, second vendor platform 420, first physical vendor location 416 (e.g., via a centralized controller 16 of first physical vendor location 416), and/or second physical vendor location 426 (e.g., via a centralized controller 16 of second physical vendor location 426).

In various embodiments, tablet 434 and/or smart phone 436 may be user-owned devices, but shopper device 432 may be a vendor supplied device available for users at physical vendor locations (e.g., first physical vendor location 416 and/or second physical vendor location 426). In any event, mobile devices 430 are associated with a user as described herein, even if such devices are not owned by the user.

In particular, tablet 434 and/or smart phone 436 may be mobile devices owned by a user, such as iPhone, iPod, or Android related devices implementing the Apple iOS operating system, Google Android system, and/or other related respective software. Such devices may include a data capture assembly (e.g., a camera or other imaging device) operable to capture product data for products located at physical vendor locations as described herein.

Shopper device 432 may be a vendor supplied device provided to a user at a physical vendor location, such as first physical vendor location 416 and/or second physical vendor location 426. Such devices are not owned by the user, but associated with the user when the visit a physical vendor location. For example, shopper device 432 may be a “personal shopper” device, such as the Zebra® MC18 Personal Shopper handheld device. Shopper device 432 may be a battery operated, hand-held device configured to implement an Android, Windows, iOS, or other mobile operating system of software. Shopper device 432 may include a data capture assembly operable to capture product data for products located at physical vendor locations as described herein. Such data capture assembly may be operable to implement 1D and 2D bar code scanning on paper labels (e.g., UPC or QR stickers) or electronic displays.

Shopper device 432 may further include a process, memory, wireless communication modules (e.g., for communicating via Wi-Fi IEEE 802.11a/b/g/n and/or Bluetooth), and a smartphone-style touch display. Shopper device 432 may also be operable or otherwise configured, to communicate with detector stations 30 or other systems (e.g., centralized server 16) as described for FIG. 1 herein. A physical vendor location (e.g., first physical vendor location 416 and/or second physical vendor location 426) may be installed multiple shopper devices, where such shopper devices (e.g., such as shopper device 432) may be stored in cradles or other locations that make them accessible to users/consumers at physical vendor location(s). In some embodiments, shopper device 432 may also be linked to a user profile of the multi-vendor cross-platform system, as described herein. For example a user profile may be linked via digital handshaking with a user mobile device. In some embodiments, such digital handshaking may be performed via short-range wireless communication or pairing, such as near-field communication (NFC) and/or BLUETOOTH standard pairing. In still further embodiments a QR code, such as QR code 508 or 558, as illustrated in FIGS. 5A and 5B, respectfully, may also be used to pair a user mobile device with shopper device 432. For example, in such embodiments, a user may scan the QR code (e.g., QR code 508 and/or 558) with shopper device 432 to initiate pairing of the user's mobile device with the shopper device 432. In specific embodiments, a QR Code (e.g., QR code 508 and/or 558) may be used across a shared user profile. Shared user profiles allow multiple users to use the same profile. For example, shared user profiles allow a group of users, such as a family, or other group of users (e.g., a group of users shopping together where one user is paying) to shop using the same QR code. In such embodiments, a first member of a shared user profile could pair a shopping device 432 with a shared QR code on a first mobile device, and a second user of the shared user profile could pair a separate shopping device 432 using the same shared QR code using a second mobile device. This would allow both the first member and the second member to use the shared user profile as a user profile as described herein. In any event, in such embodiments, after the shopper device 432 and user mobile device are paired, a user may use the mobile device and shopper device 432 in accordance with the multi-vendor cross-platform systems and methods as described herein.

As described in various embodiments herein, mobile devices 430 may be configured to implement a cross-platform mobile application (app), as illustrated, for example, by FIGS. 5A and 5B. The cross-platform mobile app is configured to implement a cross-platform interactive GUI on a mobile device (e.g., on a mobile device 430). A cross-platform mobile app may be downloaded for installation on mobile devices 430 from various mobile device platforms including, for example, Apple Store (for iOS based devices) or Google Play (for Google Android based devices). Cross-platform mobile apps may also be installed offline or otherwise not requiring such mobile device platforms.

In various embodiments, a cross-platform mobile app may be communicatively coupled to multi-vendor cross-platform cloud server 402 via computer network 406. The cross-platform mobile app may be configured to execute instructions, via one or more processors of a mobile device, to determine a current location or location setting of the mobile device, and to determine that the current location or location setting of the mobile device is at, near, or associated with one of: (i) the first physical vendor location or (ii) the second physical vendor location.

In such embodiments, the determination of the current location or location setting of the mobile device may be performed locally or remotely, for example, in one embodiment, locally via the cross-platform mobile app. Additionally, or alternatively, the determination of the current location or location setting of the mobile device may be performed remotely via the multi-vendor cross-platform cloud server 402 and/or a centralized server 16 of a physical vendor location. Such determination could be based on GPS information of the mobile device 430 upon which the cross-platform mobile app is implemented, or via tracking information generated from tracking the mobile device 430 via a detector station 30 of the physical vendor location at which the mobile device 430 is located. In such embodiments, detector station(s) 30 may be used to determine current location and/or perform various features or functionality as described herein. For example, in some embodiments, if detector station(s) 30 identify that a user lingers in an area of a physical vendor location (e.g., venue 100); store personnel might be dispatched to see if the user requires assistance. In other embodiments, in situations where suspicious or malicious behavior is determined, security personnel could use the current location to track a suspected user through a vendor location, e.g., via monitoring them with cameras of detector stations (30) or otherwise.

In other embodiments, a cross-platform mobile app could identify which physical vendor location a user is currently located in either by using the GPS location of the mobile device (e.g., smart phone 436) upon which it is implemented. In other embodiments, the current location may be determined from a location of shopper device 432 as determined from detector station(s) 30.

In still further embodiments, the current location may be determined where a user uses a shopper device with another mobile device (e.g., smartphone 436) by scanning a barcode (e.g., QR code). In such embodiments, the shopper device 432 may be paired with the smartphone 436, and, by virtue of the known location of shopper device 432 (which has a location setting set to its associated physical vendor location), enables the cross-platform mobile app (executing on the smartphone 436 in such an embodiment) to determine the current location. In some embodiments, users may be tracked, and/or current location determined, by analyzing a last product scanned with the mobile device 430/shopper device 432 against a map of the physical vendor location and product locations. In such embodiments, detector station(s) 30 may be used to perform in-store tracking.

Based on the determination of the current location of the mobile device 430, multi-vendor cross-platform cloud server 402, a vendor platform (e.g., 410 and/or 420), and/or a centralized server (e.g., a centralized server 16 of a physical vendor location 416 or 426) may transmit a set of user interfaces and/or vendor data related to the physical vendor location that aligns with the current device location. For example, in some embodiments, the cross-platform mobile app may identify a physical vendor location (e.g., first physical vendor location 416) a user is located at, which would cause the transmission of the set of user interfaces and vendor data, which may be loaded and rendered as an interactive GUI on a mobile device 430. Such interactive GUI may comprise a sales front end specific to that physical vendor location. The interactive GUI could include a unique look (e.g., implemented via different graphic “skins” or comprised of differently configured interfaces), unique layout, store specific maps and/or sales pages, etc. Embodiments of such implementations are shown, for example, in FIGS. 5A and 5B herein.

Based on a determination of the current location or location setting being at, near, or associated with the first physical vendor location 416, a cross-platform mobile app may receive first set of user interfaces 412 and related first set of vendor information from any of the multi-vendor cross-platform cloud server 402, the first vendor platform 410, and/or the centralized server 16 of the first physical vendor location 416. In such embodiments, the cross-platform mobile app may render, via a display of the mobile device, a cross-platform interactive GUI using the first set of user interfaces 416 and the first set of vendor information.

Alternatively, based on a determination of the current location or location setting being at, near, or associated with the second physical vendor location 426, the cross-platform mobile app may receive second set of user interfaces 422 and the second set of vendor information from any of the multi-vendor cross-platform cloud server 402, the second vendor platform 420, and/or the centralized server 16 of the second physical vendor location 426. In such embodiments, the cross-platform mobile app may render, via a display of the mobile device, a cross-platform interactive GUI using the second set of user interfaces 426 and the second set of vendor information.

Diagram 400 of FIG. 4 further illustrates embodiments regarding the performance of multi-vendor competitive analysis, e.g., by multi-vendor cross-platform cloud server 402, with user tracking information as received from multiple instances of the cross-platform mobile app implemented on corresponding mobile devices. In some embodiments, vendor(s) must opt-in to share vendor specific information (e.g., sales at specific physical vendor locations via the various instances of the cross-platform mobile app) in order to get the multi-vendor competitive analysis, which can include, for example competitive sales data of multiple participating, and possibly competing, vendors.

In various embodiments regarding performance of multi-vendor competitive analysis, as illustrated in FIG. 4 and as described herein, multi-vendor cross-platform cloud server 402 is communicatively coupled, via computer network 406, to first vendor platform 410 of the first vendor and second vendor platform 420 of the second vendor. As described herein, multi-vendor cross-platform cloud server 402 is configured to receive first set of user interfaces 412 and a first set of vendor information from first vendor platform 410. Similarly, multi-vendor cross-platform cloud server 402 is configured to receive a second set of user interfaces 422 and a second set of vendor information from second vendor platform 420.

In embodiments regarding performance of multi-vendor competitive analysis, multi-vendor cross-platform cloud server 402 is associated with a plurality of instances of cross-platform mobile apps implementing respective cross-platform interactive GUIs. In such embodiments, the plurality of instances is configured to execute on a plurality of mobile devices 430 associated with a plurality of users. The plurality of instances is each communicatively coupled to multi-vendor cross-platform cloud server 402 via computer network 406. In various embodiments, each of the plurality of instances are configured to execute instructions, via one or more processors of a corresponding (e.g., smartphone 436) of the plurality of mobile devices 430, to render, via a display of the corresponding mobile device (e.g., smartphone 436), a cross-platform interactive GUI. In such embodiments, the cross-platform interactive GUI is rendered using either (i) first set of user interfaces 412 and the first set of vendor information or (ii) second set of user interfaces 422 and the second set of vendor information.

In embodiments regarding performance of multi-vendor competitive analysis, each of the plurality of instances may transmit, to multi-vendor cross-platform cloud server 402, user tracking information. In such embodiments, the user tracking information may be defined as associated with either (i) the first vendor when the cross-platform interactive GUI is rendered with first set of user interfaces 412 and the first set of vendor information, or (ii) the second vendor when the cross-platform interactive GUI is rendered with second set of user interfaces 422 and the second set of vendor information. In such embodiments, multi-vendor cross-platform cloud server 402 is configured to transmit to first vendor platform 410 and second vendor platform 420, one or more cross-platform metrics determined from the user tracking information.

In various embodiments, the cross-platform metrics may include, for example, determinations made (e.g., a determinations to reduce prices to incentivize consumer purchases) based on a given customer's stored product list (e.g., as illustrated in FIGS. 5A and 5B). Such determinations may be made after receiving tracking information associated with a total price of the customer list or the type of a customer (impulse buyer, big spender, etc.). For example, in some embodiments, a vendor could offer a large coupon for a user with a product list includes a large amount of products. This may incentivize consumer purchases for that user.

Additionally, or alternatively, user data, as received from mobile device implementing instances of cross-platform mobile app(s) may be used by multi-vendor cross-platform cloud server 402 be to make determinations about, and track habits, of specific users. Users would be incentivized to allow such tracking because it would give them access to offers and incentives, as described herein, that vendors would provide, and which may not be available to users that do not allow such tracking. For example, such data may allow multi-vendor cross-platform cloud server 402 to determine whether a user typically purchases items that are not on his or her product list, which could indicate that such a user is an impulse buyer. Using such platform metrics, a vendor may offer impulse buyer users special incentives to encourage impulse purchases. Other incentives may also be implemented for other user types. In similar embodiments, high-spending and/or loyal users may receive additional offers to incentivize them to continue spending at a particular vendor.

Additionally, or alternatively, based on user tracking data, as received from mobile device implementing instances of cross-platform mobile app(s), targeted marketing campaigns may be determined. For example, a targeted marketing campaign may include sending offers to specific users that fall into a certain customer base (e.g., if a customer buys a lot of fishing supplies or bought fishing supplies recently (see, e.g., FIG. 5B), the customer may receive a special offer on a tackle box next time the user's cross-platform mobile app identifies that their current location is at a sporting goods store, or even before they go into the store.

In some embodiments, user interfaces (e.g., first set of user interfaces 412 and/or second set of user interfaces 422) may be used to generate, or may include, a page or a screen where users can opt-in to receive e-mails, offers, or notifications from a cross-platform mobile app for that store, thereby allowing for cross-platform metrics determinations and/or user tracking, as described herein.

FIG. 5A illustrates an example mobile device 500 (e.g., smartphone 436) implementing a first embodiment of a cross-platform interactive GUI 502, in accordance with various embodiments disclosed herein. Cross-platform interactive GUI 502 is executed via an instance of the cross-platform mobile app on mobile device 500. An instance is a specific instantiation of the cross-platform mobile app executing or otherwise operating in-memory of the mobile device 500. In the embodiment of FIG. 5A, cross-platform interactive GUI 502 has been rendered on the display of mobile device 500, which in the embodiment of FIG. 5a is a smartphone mobile device (e.g., smartphone 436).

As illustrated in FIG. 5A, cross-platform interactive GUI 502 has been rendered using a first “skin” (shown as a background skin) that may be preferred or otherwise used by the first vendor. For example, cross-platform interactive GUI 502, and its related skin, may relate to a first vendor that sells clothing, such as designer clothing and apparel. The first skin may, for example, be a color, trade dress, or other identifying characteristic of the first vendor. Cross-platform interactive GUI 502 is comprised of a first set of user interfaces (e.g., first set of user interfaces 412) and first set of vendor information, as illustrated in 504-546, which may be of the first vendor associated with first vendor platform 410 and/or first physical vendor location 416. Such first set of user interfaces and first set of vendor information may be sent from multi-vendor cross-platform cloud server 402 and/or first vendor platform 410 as described herein.

For example, as show in the embodiment of FIG. 5A, cross-platform interactive GUI 502 includes a logo or trademark 504 of the first vendor, and a QR code 508 of the first vendor, the latter of which may be used to pair or associate mobile device 502 with first vendor physical location 426. Such pairing may include, for example, pairing mobile device 502 with a shopper device 432 as described herein.

Cross-platform interactive GUI 502 further includes menu 506, which may be used to add user information, set settings, or otherwise interact with the cross-platform interactive GUI 502 as described herein. For example, menu 506 may include options or submenus that allow a user to enter credit card, PayPal, and/or other payment information. Such information could be sent to a vendor (e.g., first vendor platform 410 and/or first physical vendor location 418) and/or multi-vendor cross-platform cloud server 402 upon checkout as described herein. Checkout could include, for example, when the user exits the store with products, as identified in his or her product list. Additionally, or alternatively, such information may be stored locally on mobile device 500 and/or remotely at any of first vendor platform 410, first physical vendor location 418 (e.g., a centralized controller 16), and/or universal multi-vendor cross-platform cloud server 402.

Cross-platform interactive GUI 502 further includes a product list 510, also referred to herein as a “customer list,” “centralized list,” “shopping list,” “centralized shopping list,” or similar. For example, users that interact with the cross-platform interactive GUI 502 may create centralized shopping lists cause the cross-platform interactive GUI 502 to provide users with a variety of functionality and features. In the embodiment of FIG. 5A, product list 510 includes one or more products as scanned or selected by a user. In particular, product list 510 includes two products 522 and 532, namely a dress shirt and pants, respectively. In some embodiments, product list 510 may include products that the user scanned with mobile device 500 or scanned with a shopper device (e.g., shopper device 432) as paired with mobile device 500. In other embodiments, product list 510 may include products that the user pre-selected as part of a pre-selected list. For example, the pre-selected list of products may represent products that the user desires to purchase.

In still further embodiments, product list 510 may represent a vendor pre-populated list that a vendor determines from, e.g., cross-platform metrics data and/or user tracking data. For example, vendor pre-populated lists may include lists for users with certain interests or needs, or for certain user types, as determined from similar past user purchases and/or selections. Such vendor pre-populated lists may allow vendors to guide users to products that users may be interested in purchasing or need in store. For example, a vendor could have a new hiker list with essential supplies. As another example, a vendor could have a recommended low-carb diet list. As a further example, in the embodiment of FIG. 5A, product list 510 may be a vendor “new worker” pre-populated list for a new worker who needs to buy new clothes for a new job. In any event, such vendor pre-populated lists may provide vendors of the multi-vendor cross-platform systems and methods a competitive advantage over rivals that do not have such convenient lists for users.

As illustrated in FIG. 5A, certain products may be associated with certain product offers. For example, product 522 is generally sold for $49.99, but is discounted to $34.99. The discount may be associated with one or more offers, e.g., offer 1 (526) and/or offer 2 (528), which may be offers determined by the cross-platform metrics and/or user tracking data as described herein. For example, offer 1 (526) may have been included in the first set of user interfaces 412 and first set of vendor information, as used to generate cross-platform interactive GUI 502, based on upon the user's past shopping habits or history. In the embodiment of FIG. 5A, a user may have interacted with the cross-platform interactive GUI 502 by selecting offer 1 (526) to therefore cause cross-platform interactive GUI 502 to apply offer 1 (526), and, thus decrease the price from $49.99 to $34.99.

In additional embodiments, products may be removed from the product list 510, by selection of removal buttons, e.g., removal buttons 524 and 534 to remove products 524 and 534, respectively.

In some embodiments, cross-platform interactive GUI 502 further includes order options 512 and/or delivery options 514. For example, order options 512 may be a selectable option that allows a user to register for notices or status updates to inform the user when the order is ready or an estimated time of completion of the order. For example, in some embodiments, a user may leave the store, and then be notified, via the cross-platform mobile app, that an order is ready. Such notices may displayed in a messaging interface 540 as illustrated in FIG. 5A, e.g., order 323 pending (estimated time is 12 minutes). In similar embodiments, a user may initialize an order before the user arrives so that the order is ready when the user gets to the store. In some embodiments, a store could may be provided an ETA based on the user's location (e.g., as determined from the user's mobile device and/or cross-platform mobile app) to determine when an order should be filled by.

Delivery options 514 may include one or more selectable options that allow a user to schedule delivery of one or more products, e.g., products 522 and/or 532, to a user. For example, a vendor may partner with a third-party (e.g., Uber, Lfyt, etc.), or employ its own personnel, to deliver products (e.g., 522 and/or 532) to a user's home. In certain embodiments, for secure item(s) (e.g., such as prescriptions, items on hold, or custom orders) the driver picking up the secure item(s) could be sent an authorization code to his or her related delivery application that a physical vendor location could scan to verify that the driver is authorized to pick up the order.

Cross-platform interactive GUI 502 further includes features regarding product pricing across multiple vendors, efficient itineraries for visiting multiple vendors, etc. For example, in some embodiments, cross-platform interactive GUI 502 may allow a user to check price(s) of products 522 and/or 532 in product list 510 of the first vendor against other vendors to determine what the best price on each item is. The cross-platform interactive GUI 502 may also display which physical vendor location has the least expensive overall price on all product list 510 list items. Additionally, or alternatively, cross-platform interactive GUI 502 may also recommend, based on product list 510, which physical vendor location(s) would require the least amount of physical vendor location visits in order to supply all the items in product list 510. Additionally, or alternatively, cross-platform interactive GUI 502 may also determine based on product list 510, the closest physical vendor location(s) relative to a location of the user and/or the most efficient route to such physical vendor location(s). It could also utilize traffic data to find the store that is the quickest to get to. Additionally, or alternatively, cross-platform interactive GUI 502 may also factor in store hours in making recommendations. In this way, users that shop at late hours, or early in the morning, would only have physical vendor locations that are open at that time recommended to them. Other information may also be received, and, in some embodiments, information received by the app may be specific to the store, specific to the geographic location, or some combination thereof. For example, as shown in itinerary interface 542, cross-platform interactive GUI 502 may recommend (e.g., at 9:41 am) that the user first visit vendor A (e.g., first vendor as described herein) to purchase the items in product list 510, with an expected arrival time at 10:17 am, and recommend that the user next visit vendor B (e.g., second vendor as described herein) to purchase the items in product list 560 (of FIG. 5B), with an expected arrival time at 11:17 am. The itinerary may have been generated because vendor A opens at 10:00 am and vendor B opens at 11:00 am.

Cross-platform interactive GUI 502 further includes a rating interface 544. Rating interface may allow a user to rate, review, and submit feedback for specific physical vendor locations (e.g., how many stars the physical vendor location receives). Additionally, or alternatively, users could submit feedback or suggestions, e.g., via a text box (not shown). In either embodiment, other users may then view a physical vendor location's rating and/or related user comments to decide if they want to shop at that physical vendor location. Such a rating system may encourage vendors to improve operations at the physical vendor location. For example, feedback submitted via rating interface 544 could be reviewed by the physical vendor location's management to assist management drive positive improvement.

Cross-platform interactive GUI 502 further includes a reward point interface 546. For example, cross-platform interactive GUI 502, and cross-platform cloud server 402, could track loyalty program(s), such as rewards points (e.g., 457 reward points as illustrated in FIG. 5A) and/or electronic offers to factor into list price recommendations (e.g., product list 510). The points could be used to purchase, at least partially, products (e.g., products 522 and 532).

In additional embodiments, vendors may also send emails with special deals that could be added to the app as virtual offers (e.g., offers 1 (526) and 2 (528)). In some embodiments, the offers may be stored on the app. In other embodiments, the virtual offers may be stored remotely, such as at multi-vendor cross-platform cloud server 402.

Cross-platform mobile app(s) may also include built-in security features. In some embodiments, cross-platform mobile apps may assist vendors reduce shrinkage events. For example, a cross-platform mobile app may determine a particular user is a security threat via compiled data in the multi-vendor cross-platform cloud server 402 (e.g., in database 403) that represents past shrinkage events associated with the particular user. Such data may be compiled across multiple physical vendor locations. In some embodiments, a cross-platform mobile app may be used in conjunction with a camera system (e.g., detector stations 30) to detect suspicious behavior (e.g., a person lingering and seen on the camera to be stuffing something inside a coat). Such incidents might be recorded to the multi-vendor cross-platform cloud server 402 that would store the user's data so other participating vendors could be made aware that a potential thief is in the store. Additionally, or alternatively, cross-platform mobile app(s) may set red flags to alert a physical vendor location's security team when a risk user arrives. Security personnel may also be able to flag an individual that they suspect of stealing so that such users who use the cross-platform mobile app in any participating vendor may be alerted to the individual's presence. Additionally, or alternatively, when an RFID detector (e.g., detector station 30) is used at the exit of a physical vendor location, the multi-vendor cross-platform system, through use of detection stations 30, can compare against the user's purchased list to determine that all products in the customer's list is what the customer has paid for. If an item that hasn't been paid for is found, the multi-vendor cross-platform system could alert the customer to return to the store and/or alert store security.

FIG. 5B illustrates an example mobile device 550 (e.g., smartphone 436) implementing a second embodiment of a cross-platform interactive GUI 552, in accordance with various embodiments disclosed herein. In various embodiments, mobile device 550 and/or cross-platform interactive GUI 552 may be identical or similar to mobile device 500 and/or cross-platform interactive GUI 502. Accordingly, the disclosure herein for mobile device 500 and/or cross-platform interactive GUI 502 applies equality and/or similarly for mobile device 550 and/or cross-platform interactive GUI 552. In other embodiments, however, mobile device 550 and/or cross-platform interactive GUI 552 may represent a different mobile device (e.g., 430) with a different cross-platform interactive GUI, or other combination thereof. In addition, it is to be understood that cross-platform interactive GUIs are not limited to embodiments of FIGS. 5A and 5B, which illustrate smartphone embodiments. Instead, cross-platform interactive GUIs may be implemented on various other mobile devices, including any of mobile devices 430 as described herein.

In the embodiment of FIG. 5B, cross-platform interactive GUI 552 has been rendered on the display of mobile device 550, which in the embodiment of FIG. 5B is a smartphone mobile device (e.g., smartphone 436). As illustrated in FIG. 5B, cross-platform interactive GUI 552 has been rendered using a second “skin” (shown as a background skin) that may be preferred or otherwise used by the second vendor. For example, cross-platform interactive GUI 552 may relate to a second vendor that sells sporting goods, such as finishing equipment. The second skin may, for example, be a color, trade dress, or other vendor characteristic of the second vendor. The cross-platform interactive GUI 552 is comprised of a second set of user interfaces (e.g., second set of user interfaces 422) and second set of vendor information, illustrated in 554-596, which may be of the second vendor associated with second vendor platform 420 and/or second physical vendor location 426. Such second set of user interfaces and second set of vendor information may be sent from multi-vendor cross-platform cloud server 402 as described herein.

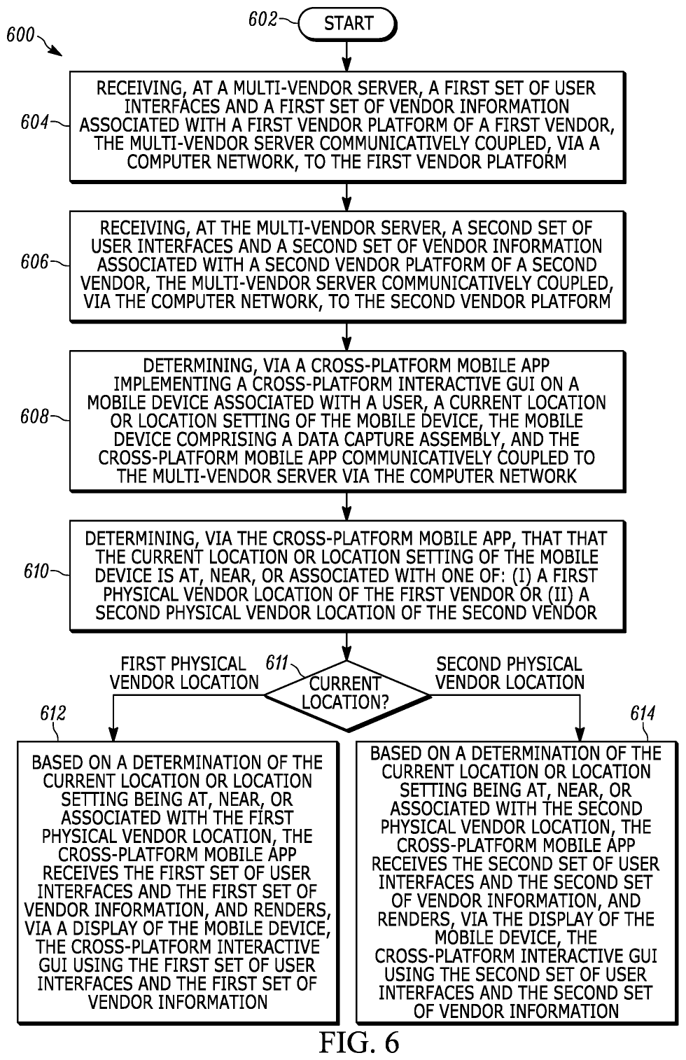

FIG. 6 is a flow chart of an example universal multi-vendor cross-platform method 600 for implementing cross-platform interactive GUIs, in accordance with various embodiments disclosed herein. Method 600 begins (602) at block 604 where a multi-vendor server (e.g., multi-vendor cross-platform cloud server 402) receives a first set of user interfaces (e.g., first set of user interfaces 412) and a first set of vendor information associated with a first vendor platform (e.g., first vendor platform 410) of a first vendor. As described herein, the first set of user interfaces includes one or more user interface skins for rendering cross-platform interactive GUI(s). Additionally, or alternatively, the first set of vendor information includes product information of one or more products associated with the first vendor. The multi-vendor server may be communicatively coupled, via a computer network (e.g., computer network 406), to the first vendor platform. In some embodiments, the first set of user interfaces and the first set of vendor information may be received from the first vendor platform.

At block 606 the multi-vendor server (e.g., multi-vendor cross-platform cloud server 402) receives a second set of user interfaces (e.g., a second set of user interfaces 422) and a second set of vendor information associated with a second vendor platform (e.g., a second vendor platform 420) of a second vendor. The multi-vendor server may be communicatively coupled, via a computer network (e.g., computer network 406), to the second vendor platform. In some embodiments, the second set of user interfaces and the second set of vendor information may be received from the second vendor platform.

At block 608 a cross-platform mobile app implementing a cross-platform interactive GUI on a mobile device (e.g., a mobile device 430), as described herein, may determine a current location or location setting of the mobile device (e.g., mobile device 430). The mobile device (e.g., mobile device 430) mobile device may include a data capture assembly. In various embodiments, the cross-platform mobile app is configured to execute instructions, via the one or more processors of the mobile device (e.g., a mobile device 430), to capture, via the data capture assembly, one or more product identifiers of one or more products onsite at a physical vendor location. In addition, the cross-platform mobile app, executing on the mobile device (e.g., mobile device 430), may be communicatively coupled to the multi-vendor server (e.g., a multi-vendor cross-platform cloud server 402) via the computer network (e.g., computer network 406). As described in various embodiments herein, in some embodiments, the mobile device may be a user device of the user (e.g., such as smartphone 436).

At block 610, the cross-platform mobile app may determine (e.g., using GPS of the mobile device or via a detector station 30 of a physical vendor location) that that the current location or location setting of the mobile device (e.g., mobile device 430) is at, near, or associated with one of: (i) a first physical vendor location (e.g., a first vendor platform 410) of the first vendor or (ii) a second physical vendor location (e.g., a second vendor platform 420) of the second vendor.

At block 611, a determination, e.g., by the multi-vendor cross-platform cloud server 402 and/or the cross-platform mobile app, is made as to whether the current location with associated with the first physical vendor location (e.g., first physical vendor location 416) or the second vendor location (e.g., second physical vendor location 426). As described herein, in some embodiments, the current location may be determined based on a GPS location of the mobile device (e.g., mobile device 430). For example, in certain embodiments, the current location may be determined based on pairing the user device with a stand-alone scanner (e.g., scanner 432). In such embodiments, the act of pairing the user device (e.g., smartphone 436) with the stand-alone scanner includes the user device (e.g., smartphone 436) displaying a code for the stand-alone scanner (e.g., scanner 432) to scan.

In other embodiments, the mobile device may be a scanning device of the first vendor or the second vendor, e.g., a stand-alone scanner (e.g., scanner 432) by itself. In such embodiments, a location setting may be stored in, and accessible from, a memory of the scanning device.

In particular, based on a determination, e.g., by the multi-vendor cross-platform cloud server 402 and/or the cross-platform mobile app at block 611, of the current location or location setting being at, near, or associated with the first physical vendor location (e.g., first physical vendor location 416), then, at block 612, the cross-platform mobile app receives the first set of user interfaces (e.g., a first set of user interfaces 412) and the first set of vendor information, and renders, via a display of the mobile device (e.g., mobile device 430), a cross-platform interactive GUI (e.g., as illustrated by FIG. 5A) using the first set of user interfaces (e.g., a first set of user interfaces 412) and the first set of vendor information.

Alternatively, based on a determination, e.g., by the multi-vendor cross-platform cloud server 402 and/or the cross-platform mobile app at block 611, of the current location or location setting being at, near, or associated with the second physical vendor location (e.g., second physical vendor location 426), then, at block 614, the cross-platform mobile app receives the second set of user interfaces (e.g., a second set of user interfaces 422) and the second set of vendor information, and renders, via a display of the mobile device (e.g., mobile device 430), a cross-platform interactive GUI (e.g., as illustrated by FIG. 5B) using the second set of user interfaces (e.g., a second set of user interfaces 412) and the second set of vendor information.

With reference to FIGS. 4, 5A, 5B, and 6, multi-vendor cross-platform cloud server 402 may maintain, in a memory (e.g., database 403), a user profile of a user. In such embodiments, the user profile may include a list of one or more pre-selected products (e.g., products 522, 532, 572, and/or 582). The pre-selected products may be products selected by the user or part of a vendor pre-populated list as described herein. In some embodiments, a cross-platform mobile app may execute instructions to compare a first price of a particular product (e.g., product 522) of the one or more pre-selected products offered by the first vendor to a second price of the particular product offered by the second vendor.

In still further embodiments, the cross-platform mobile application may execute instructions to recommend a shopping itinerary (e.g., as illustrated by itinerary interfaces 542 and 592 of FIGS. 5A and 5B) based on the list of one or more pre-selected products. In such embodiments, the shopping itinerary may include a first time to arrive at the first vendor location and a second time to arrive at the second vendor location (e.g., as illustrated by itinerary interfaces 542 and 592 of FIGS. 5A and 5B). The first time and second time may each be determined based on traffic condition data or vendor operating hour's data. For example, the cross-platform mobile application may use GPS information of the mobile device to determine the most efficient route to multiple physical vendor locations to fulfill the customer's list. As a specific example, the cross-platform mobile application use the customer's list to determine a fewest number of physical vendor locations the customer needs to visit in order to buy the items on the customer list.

In some embodiments, a consumer may desire to prioritize user preferences, e.g., a user can choose whether he or she wants the cheapest, fastest, or highest rated shopping experience. Such preferences may be selected, for example, from menus 506/556 as described herein for FIGS. 5A and 5B. In such embodiments, the cross-platform mobile app may then determine, based on the user's shopping list, which physical vendor location(s) can best fulfill their needs. In a particular embodiment, for example, the cross-platform mobile app may be configured to execute instructions, via the one or more processors of the mobile device (e.g., mobile device 430), to receive a user prioritization selection via menu 506/556. In such embodiments, the user prioritization selection may cause the cross-platform mobile app to display a recommendation for the first physical vendor location (e.g., first vendor location 416) and/or the second physical vendor location (e.g., second vendor location 426).

In some embodiments, the cross-platform mobile app may be configured to execute instructions, via one or more processors of the mobile device (e.g., mobile device 430), to render via the display, a pre-populated list of products based on a pre-determined interest. In such embodiments, the cross-platform mobile application may display a price difference between a first vendor and second vendor for an entire list of products that a user has in his or her product list (e.g., product list 510 and/or 560). For example, in such embodiments, a cross-platform mobile application may execute further instructions to compare a first total price of a plurality of one or more pre-selected products offered by the first vendor (e.g., a total price for product list 510) to a second total price of a plurality of one or more pre-selected products offered by the second vendor (e.g., a total price for product list 560).

In some embodiments, the first or second vendor may upload from the first or second vendor platform (410 or 420), respectively, one or more electronic coupons or electronic offers (e.g., offer 1 (526/576) and offer 2 (526/578) as illustrated by FIGS. 5A and 5B) corresponding to one or more pre-selected products of a user product list (510 and/or 520). In this way, vendors may analyze a user or customer list (e.g., product list 510 and/or 520) to generate offers based on rules applied to the list to try and encourage customers to shop at specific physical vendor locations (e.g., first physical vendor location 416 and/or second physical vendor location 426). In such a way, user spending habits may be also recorded by the multi-vendor cross-platform cloud server 402 and/or by vendor platforms 410 and/or 420, which would assist vendors set rules based on which type of customers they are willing to lower prices for, offer coupons/rewards for, etc. For example, in such embodiments, one or more electronic coupons or electronic offers (e.g., offer 1 (526/576) and offer 2 (526/578) as illustrated by FIGS. 5A and 5B) may be based on the one or more pre-selected products or the user's purchasing activity. In still further related embodiments, a type or an amount of the one or more electronic coupons (e.g., offer 1 (526/576) and offer 2 (526/578) as illustrated by FIGS. 5A and 5B) may vary based on a quantity of the one or more pre-selected products, e.g., in product lists 510 and/or 520 or on a shopping type of the user. For example, a shopping type of a user may be one or more of an impulse-buyer shopping type or a high-spending shopping type. Other shopping types are contemplated herein. Additionally, or alternatively, a vendor may set rules that allow the vendor to reduce or match prices and/or offers to a competitor on a given customer's list based on size of the list or known customer behaviors or habits.

In various embodiments, the cross-platform mobile app may include a task engine (e.g., instructions built into the cross-platform mobile app) configured to execute one or more first or second vendor tasks. In such embodiments, the one or more vendor tasks may be defined by the first and/or second vendor and uploaded from a respective vendor platform (410 and/or 420) to multi-vendor cross-platform cloud server 402. The one or more vendor tasks may be received, via computer network 406, by the cross-platform mobile app from multi-vendor cross-platform cloud server 402. A user may access, set, and/or configure tasks via menu 506/556 as illustrate by FIGS. 5A and 5B.

In one embodiment, the one or more vendor tasks may include a restocking task. Such restocking tasks may be configured to cause the cross-platform mobile app to notify the first vendor, via the first vendor platform 410, that a desired product is low or out of stock.

In additional embodiments, the one or more vendor tasks may include a customer assistance task. The customer assistance task may be configured to cause the cross-platform mobile app to notify personnel of a physical vendor location of a user. For example, in a certain embodiment, the customer assistance task may be triggered when the user has remained stationary within a physical vendor location (e.g., first physical vendor location 416 and/or second physical vendor location 426) for a set period of time (e.g., 5 minutes). In additional embodiments, one or more vendor tasks may include a second customer assistance task configured to allow the user to request assistance while at the physical vendor location (e.g., first physical vendor location 416 and/or second physical vendor location 426). For example, in such embodiment, the user may be able to trigger the assistance in the app, e.g., via menu 506/556.

In additional embodiments, the one or more vendor tasks may further include a security task. In such embodiments, the security task may be configured to cause the cross-platform mobile app to track, via one or more sensors (e.g., via sensors of detector station(s) 30), the user within a vendor location (e.g., first physical vendor location 416 and/or second physical vendor location 426). For example, in some embodiments, the cross-platform mobile app, via a mobile device (e.g., mobile device 430) associated with the user, may track a location (e.g., via GPS) of the user within a physical vendor location. The location of the user may be made available to the first vendor platform and/or server of the physical vendor location for tracking the user throughout the physical vendor location. Such locationing and tracking may allow a vendor employee to find the user even if they continue moving within the physical vendor location.

In additional security related embodiments, the cross-platform mobile application may further execute instructions to transmit security-related data to multi-vendor cross-platform cloud server 402 based on activity of the user at a physical vendor location (e.g., first physical vendor location 416), wherein the security-related data is made available to a second vendor platform (e.g., second vendor platform 420) when the user visits the second physical vendor location (e.g., second physical vendor location 426). In an additional security related embodiment, one or more vendor tasks may include a second security task. The second security task may be configured to cause the cross-platform mobile app to track, via one or more products as captured by the data capture assembly of the mobile device, the user within the a vendor location. The tracking may be performed, for example, by detector stations 30 in a physical vendor location that tracks RFIDs of the one or more products captured by the data capture assembly.

In additional embodiments, one or more vendor tasks may include an onsite notice task. The onsite notice task may be configured to cause a cross-platform mobile app to send one or more notices to the user regarding status of one or more corresponding orders. Such embodiments are illustrated via messaging interfaces 540 and/or 590 of FIGS. 5A and 5B.

In additional embodiments, one or more vendor tasks may include a pre-order task. The pre-order task may be configured to cause a cross-platform mobile app to display a pre-order interface selected from first set of user interfaces allowing the user to preorder one or more products. For example, a user may the app to pre-order items from a vendor like deli, bakery, balloons, etc. This will help speed the shopping experience, too. Such embodiments are illustrated in FIGS. 5A and 5B, where a user may be used order options 512/562 to pre-order order 545, which has shown via messaging interface 540/590, is pending with an estimated time of 12 minutes.

In additional embodiments, a purchase of one or more products (e.g., products 522 and 532 of product list 510) may cause a vendor platform (e.g., first vendor platform 420 or second vendor platform 410) to assign to the user profile, via multi-vendor cross-platform cloud server 402, one or more reward points, as illustrated, for example, by reward point interfaces 546 and/or 596 of FIGS. 5A and 5B.

In additional embodiments, a cross-platform mobile app may further be configured to execute instructions, via one or more processors of a mobile device (e.g., mobile device 430) to, using a set of user interfaces and a set of vendor information (e.g., first set of user interfaces 412 and first set of vendor information), display a review screen (e.g., 544 of FIG. 5A) allowing the user to provide review information associated with a physical vendor location (e.g., first physical vendor location 416).

In some embodiments, a user may select delivery options (e.g., delivery options 514). In such embodiments, the cross-platform mobile app may be configured to execute instructions, via one or more processors of the mobile device (e.g., mobile device 430) to, using a set of user interfaces and a set of vendor information (e.g., first set of user interfaces 412 and first set of vendor information), display a service-shop screen allowing the user to select products available at the related physical vendor location for delivery by a third-party service to the user at a remote location (e.g., at the user's home). In such embodiments, multi-vendor cross-platform cloud server 402 may be configured to provide the third-party service with an authorization code that may be required to allow the third-party service to retrieve the selected products (e.g., prescription pharmaceuticals, etc.).

In still further embodiments, cross-platform mobile app may be configured to execute instructions causing one or more products of a user's product list, such as product list 510 and/or 560, to be purchased when the user travels a distance away from a physical vendor location (e.g., first physical vendor location 416 and/or second physical vendor location 426). In similar embodiments, a cross-platform mobile app may be configured to execute instructions causing the one or more products of a user's product list, such as product list 510 and/or 560, to be compared with one or more corresponding radio frequency identifier (RFID) tags associated with the user, or within the close proximity of the user, when the user travels a distance away from the physical vendor location, e.g., such as through an exit of the physical vendor location.

In additional embodiments, cross-platform mobile app may be configured to execute instructions on a mobile device (e.g., mobile device 430) causing at least one of the products of the one or more products (e.g., in a product list 510 and/or 560) to be removed from a list (e.g., product list 510 and/or 560) when the at least one product is removed from a cart. For example, in some embodiments, a user may delete or remove a product that the user removed from his or her shopping cart by selecting a “remove” option in the app and then by scanning a product barcode of the at least one product to remove it from their list.

In additional embodiments, cross-platform mobile app may further be configured to execute instructions causing at least one of the products of the one or more products to be removed from a list (e.g., product list 510 and/or 560) of the one or more products when the user travels a distance away from the at least one of the products. In such embodiments, a user moving away from a product may indicate that the user is no longer interested in the product. Additionally, or alternatively, a user may select a product to be removed from the list if the user decides not to buy it, e.g., by selecting remove buttons 524 and 534 and/or remove buttons 574 and 584 as illustrated in FIGS. 5A and 5B, respectively).

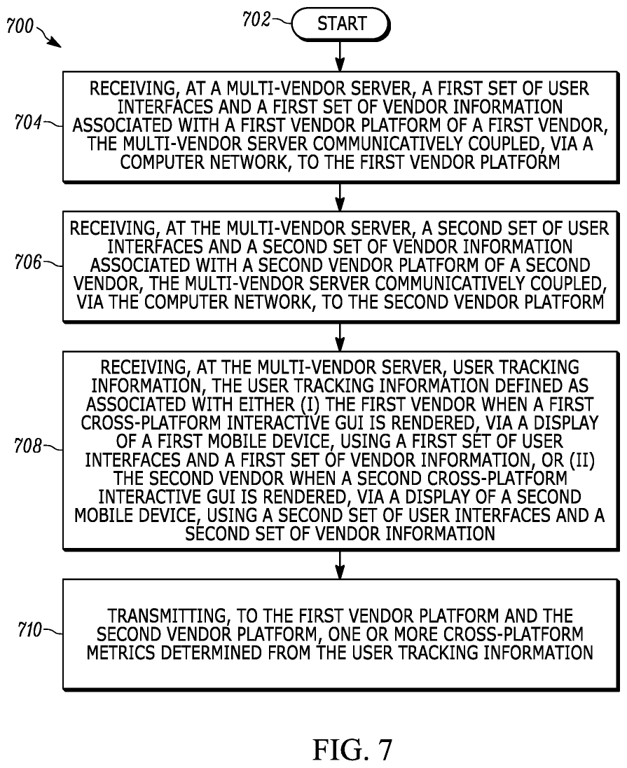

FIG. 7 is a flow chart of an example universal multi-vendor cross-platform method 700 for multi-vendor competitive analysis, in accordance with various embodiments disclosed herein. As described herein, multi-vendor competitive analysis may include, for example, competitive sales tracking and comparison data, and other data that may be determined from compiled user data, vendor data, and/or other similar data as received by multi-vendor cross-platform cloud server 402. In some embodiments, multi-vendor competitive analysis may be enabled, e.g., by multi-vendor cross-platform cloud server 402, when a vendor opts-in to multi-vendor competitive analysis or otherwise agrees, by sharing or uploading its own vendor data for analysis purposes, with multi-vendor cross-platform cloud server 402. For example, a vendor may agree to allow multi-vendor cross-platform cloud server 402 to analyze data received by the vendor's users who are executing instances of cross-platform mobile app(s) via cross-platform interactive GUI(s) for the vendor's physical locations as described herein. Such data may include how a vendor gets, or loses, customers to its physical vendor location(s), dollar revenue gained via user's use of cross-platform mobile app(s) on different product categories, and/or comparison of such analytics against other competing vendor(s). Accordingly, by opting in to the multi-vendor competitive analysis, a vendor may gain analysis, data, or other insights into competitive advantages for their own customers and with respect to competing vendors, thereby increasing the benefit and advantage of universal multi-vendor cross-platform system and methods among vendors.

Method 700 begins (702) at block 704 where multi-vendor cross-platform cloud server 402 receives a first set of user interfaces (e.g., first set of user interfaces 412) and a first set of vendor information associated with a first vendor platform (e.g., first vendor platform 410) of a first vendor. As described herein, multi-vendor cross-platform cloud server 402 is communicatively coupled, via a computer network 406, to first vendor platform 410.

At block 706 multi-vendor cross-platform cloud server 402 receives a second set of user interfaces (e.g., second set of user interfaces 422) and a second set of vendor information associated with a second vendor platform (e.g., second vendor platform 420) of a second vendor. As described herein, multi-vendor cross-platform cloud server 402 is communicatively coupled, via a computer network 406, to second vendor platform 420.

At block 708, multi-vendor cross-platform cloud server 402 receives user tracking information defined as associated with either (i) the first vendor when a first cross-platform interactive GUI is rendered, via a display of a first mobile device (e.g., a mobile device 430), using a first set of user interfaces (e.g., first set of user interfaces 412) and a first set of vendor information, or (ii) the second vendor when a second cross-platform interactive GUI is rendered, via a display of a second mobile device (e.g., a mobile device 430), using a second set of user interfaces (e.g., second set of user interfaces 422) and a second set of vendor information. Each of the first cross-platform interactive GUI and the second cross-platform interactive GUI is communicatively coupled to multi-vendor cross-platform cloud server 402 via computer network 406.

At block 710, multi-vendor cross-platform cloud server 402 transmits to first vendor platform 410 and second vendor platform 420, one or more cross-platform metrics determined from the user tracking information. In some embodiments, the cross-platform metrics may be transferred to first vendor platform 410 and/or second vendor platform 420 only if first vendor platform 410 and/or second vendor platform 420 have opted-in to sharing user data as described herein (e.g., sharing user data as provided from instances of cross-platform mobile app(s) via cross-platform interactive GUI(s) as described herein).

In some embodiments, the user tracking information, as determined via method 700 or elsewhere herein, may include a number of trips a user made to a first physical vendor location (e.g., first physical vendor location 416) and a number of trips the user made to a second physical vendor location (e.g., second physical vendor location 426). Additionally, or alternatively, user tracking information may include an amount a user spent at a first physical vendor location (e.g., first physical vendor location 416) and an amount the user spent at a second physical vendor location (e.g., second physical vendor location 426).

In additional embodiments, multi-vendor cross-platform cloud server 402 may generate a prediction, based on the user tracking information, regarding an electronic coupon value to offer to the user (e.g., as illustrated by offers 1 and 2 in FIGS. 5A and 5B). In such embodiments, the prediction may be transmitted to the first vendor platform, the second vendor platform, or directly to an instance of a cross-platform mobile app and/or cross-platform interactive GUI(s).

In additional embodiments, user tracking information may include shrink or theft related information for a particular user. Such shrink related information may include past history or events related to theft or suspected theft of the particular user.

In additional embodiments, the user tracking information may include user location information defining a plurality of user locations of a plurality of users within either the first physical vendor location (e.g., first physical vendor location 416) or the second physical vendor location (e.g., second physical vendor location 426). In such embodiments, such tracking information may be used to track where users typically reside within particular physical vendor locations inside. These way vendors can decide where to set up displays or sale notices, etc.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A universal multi-vendor cross-platform system for implementing cross-platform interactive guided user interfaces (GUIs), the universal multi-vendor cross-platform system comprising:
a multi-vendor server communicatively coupled, via a computer network, to a first vendor platform of a first vendor and a second vendor platform of a second vendor, each of the first vendor platform and the second vendor platform remote to the multi-vendor server, the multi-vendor server configured to:
receive a first set of user interfaces and a first set of vendor information associated with the first vendor platform,
receive a second set of user interfaces and a second set of vendor information associated with the second vendor platform,
wherein the first vendor is associated with a first physical vendor location and the second vendor is associated with a second physical vendor location; and
a cross-platform mobile application (app) implementing a cross-platform interactive GUI on a mobile device associated with a user, the mobile device comprising a data capture assembly, and the cross-platform mobile app communicatively coupled to the multi-vendor server via the computer network, the cross-platform mobile app configured to execute instructions, via one or more processors of the mobile device, to:
determine a current location or location setting of the mobile device, and
determine that the current location or location setting of the mobile device is at, near, or associated with one of: (i) the first physical vendor location or (ii) the second physical vendor location,
wherein based on a determination of the current location or location setting being at, near, or associated with the first physical vendor location, the cross-platform mobile app receives the first set of user interfaces and the first set of vendor information, and renders, via a display of the mobile device, the cross-platform interactive GUI using the first set of user interfaces and the first set of vendor information,
wherein, based on a determination of the current location or location setting being at, near, or associated with the second physical vendor location, the cross-platform mobile app receives the second set of user interfaces and the second set of vendor information, and renders, via the display of the mobile device, the cross-platform interactive GUI using the second set of user interfaces and the second set of vendor information.

2. The universal multi-vendor cross-platform system of claim 1, wherein the first set of user interfaces includes one or more user interface skins for rendering the cross-platform interactive GUI.

3. The universal multi-vendor cross-platform system of claim 1, wherein the first set of vendor information includes product information of one or more products associated with the first vendor.

4. The universal multi-vendor cross-platform system of claim 1, wherein the mobile device is a user device of the user.

5. The universal multi-vendor cross-platform system of claim 4, wherein the current location is determined based on a GPS location of the mobile device.

6. The universal multi-vendor cross-platform system of claim 4, wherein the current location is determined based on pairing the user device with a stand-alone scanner.

7. The universal multi-vendor cross-platform system of claim 6, wherein the act of pairing the user device with the stand-alone scanner includes the user device displaying a code for the stand-alone scanner to scan.

8. The universal multi-vendor cross-platform system of claim 1, wherein the mobile device is a scanning device of the first vendor.

9. The universal multi-vendor cross-platform system of claim 8, wherein the location setting is stored in a memory of the scanning device.

10. The universal multi-vendor cross-platform system of claim 1, wherein the multi-vendor server maintains, in a memory, a user profile of the user.

11. The universal multi-vendor cross-platform system of claim 10, wherein the user profile includes a list of one or more pre-selected products.

12. The universal multi-vendor cross-platform system of claim 11, wherein the cross-platform mobile application further executes instructions to compare a first price of a particular product of the one or more pre-selected products offered by the first vendor to a second price of the particular product offered by the second vendor.

13. The universal multi-vendor cross-platform system of claim 11, wherein the cross-platform mobile application further executes instructions to recommend a shopping itinerary based on the list of one or more pre-selected products.

14. The universal multi-vendor cross-platform system of claim 13, wherein the shopping itinerary includes a first time to arrive at the first vendor location and a second time to arrive at the second vendor location, the first time and second time each determined based on traffic condition data or vendor operating hours data.

15. The universal multi-vendor cross-platform system of claim 11, wherein the first vendor uploads, from the first vendor platform, one or more electronic coupons or electronic offers corresponding to the one or more pre-selected products.

16. The universal multi-vendor cross-platform system of claim 15, a type or an amount of the one or more electronic coupons varies based on a quantity of the one or more pre-selected products or on a shopping type of the user.

17. The universal multi-vendor cross-platform system of claim 16, wherein the shopping type is one or more of an impulse-buyer shopping type or a high-spending shopping type.

18. The universal multi-vendor cross-platform system of claim 10, wherein the cross-platform mobile app is further configured to execute instructions, via the one or more processors of the mobile device, to capture, via the data capture assembly, one or more product identifiers of one or more products onsite at the first physical vendor location.

19. The universal multi-vendor cross-platform system of claim 18, wherein the cross-platform mobile app is further configured to execute instructions causing the one or more products to be purchased when the user travels a distance away from the first physical vendor location.

20. The universal multi-vendor cross-platform system of claim 19, wherein purchasing one or more products causes the first vendor platform to assign to the user profile, via the multi-vendor server, one or more reward points.

21. The universal multi-vendor cross-platform system of claim 18, wherein the cross-platform mobile app is further configured to execute instructions causing the one or more products to be compared with one or more corresponding radio frequency identifier (RFID) tags when the user travels a distance away from the first physical vendor location.

22. The universal multi-vendor cross-platform system of claim 1, wherein the cross-platform mobile app is further configured to execute instructions, via one or more processors of the mobile device, to, using the first set of user interfaces and a first set of vendor information, display a review screen allowing the user to provide review information associated with the first physical vendor location.

23. The universal multi-vendor cross-platform system of claim 1, wherein the cross-platform mobile app is further configured to execute instructions, via one or more processors of the mobile device, to, using the first set of user interfaces and a first set of vendor information, display a service-shop screen allowing the user to select products available at the first physical vendor location for delivery by a third-party service to the user at a remote location.

24. The universal multi-vendor cross-platform system of claim 23, wherein the multi-vendor server is configured to provide the third-party service with an authorization code, the authorization code required to allow the third-party service to retrieve the selected products.

25. The universal multi-vendor cross-platform system of claim 1, wherein the cross-platform mobile app includes a task engine configured to execute one or more first vendor tasks, the one or more first vendor tasks defined by the first vendor and uploaded from the first vendor platform to the multi-vendor server, the one or more first vendor tasks received by the cross-platform mobile app from the multi-vendor server.

26. The universal multi-vendor cross-platform system of claim 25, wherein the one or more first vendor tasks includes a restocking task, the restocking task configured to cause the cross-platform mobile app to notify the first vendor, via the first vendor platform, that a desired product is low or out of stock.

27. The universal multi-vendor cross-platform system of claim 25, wherein the one or more first vendor tasks includes a customer assistance task, the customer assistance task configured to cause the cross-platform mobile app to notify personnel of the first physical vendor location to the user, the customer assistance task triggered when the user has remained stationary within the first physical vendor location for a set period of time.

28. The universal multi-vendor cross-platform system of claim 25, wherein the one or more first vendor tasks includes a security task, the security task configured to cause the cross-platform mobile app to track, via one or more sensors, the user within the first vendor location.

29. The universal multi-vendor cross-platform system of claim 25, wherein the cross-platform mobile application further executes instructions to transmit security-related data to the multi-vendor server based on activity of the user at the first physical vendor location, wherein the security-related data is made available to the second vendor platform when the user visits the second physical vendor location.

30. The universal multi-vendor cross-platform system of claim 25, wherein the one or more first vendor tasks includes a second security task, the second security task configured to cause the cross-platform mobile app to track, via one or more products as captured by the data capture assembly of the mobile device, the user within the first vendor location.

31. The universal multi-vendor cross-platform system of claim 25, wherein the one or more first vendor tasks includes an onsite notice task, the onsite notice task configured to cause the cross-platform mobile app to send one or more notices to the user regarding status of one or more corresponding orders.

32. The universal multi-vendor cross-platform system of claim 1, wherein the cross-platform mobile app is further configured to execute instructions, via one or more processors of the mobile device, to render via the display, a pre-populated list of products based on a pre-determined interest.

33. The universal multi-vendor cross-platform system of claim 1, wherein the first set of user interfaces and the first set of vendor information is received from the first vendor platform.

34. The universal multi-vendor cross-platform system of claim 1, wherein the second set of user interfaces and the second set of vendor information is received from the second vendor platform.

35. The universal multi-vendor cross-platform system of claim 11, wherein the cross-platform mobile application further executes instructions to compare a first total price of a plurality of the one or more pre-selected products offered by the first vendor to a second total price of the plurality of the one or more pre-selected products offered by the second vendor.

36. The universal multi-vendor cross-platform system of claim 18, wherein the cross-platform mobile app is further configured to execute instructions causing at least one of the products of the one or more products to be removed from a list of the one or more products accessible via the mobile app when the user travels a distance away from the at least one of the products.

37. The universal multi-vendor cross-platform system of claim 25, wherein the one or more first vendor tasks includes a pre-order task, the pre-order task configured to cause the cross-platform mobile app to display a pre-order interface selected from first set of user interfaces allowing the user to preorder one or more products.

38. The universal multi-vendor cross-platform system of claim 25, wherein the one or more first vendor tasks includes a second customer assistance task, the second customer assistance task configured to allow the user to request assistance while at the first physical vendor location.

39. The universal multi-vendor cross-platform system of claim 27, wherein the cross-platform mobile app tracks a location of the user within the first physical vendor location, the location of the user available to the first vendor platform for tracking the user throughout the first physical vendor location.

40. The universal multi-vendor cross-platform system of claim 11, wherein the cross-platform mobile app is further configured to execute instructions, via the one or more processors of the mobile device, to receive a user prioritization selection, the user prioritization selection causing the cross-platform mobile app to display a recommendation for the first physical vendor location or the second physical vendor location.

41. The universal multi-vendor cross-platform system of claim 15, wherein the one or more electronic coupons or electronic offers are based on the one or more pre-selected products or the user's purchasing activity.

42. The universal multi-vendor cross-platform system of claim 18, wherein the cross-platform mobile app is further configured to execute instructions causing at least one of the products of the one or more products to be removed from a list of the one or more products accessible via the mobile app when the at least one of the one or more products is removed from a cart.

43. The universal multi-vendor cross-platform system of claim 18, wherein the cross-platform mobile app is further configured to execute instructions causing at least one of the products of the one or more products to be removed from a list of the one or more products accessible via the mobile app when a selection to remove the at least one of the one or more products is selected via the mobile app and the at least one of the one or more products is scanned via the mobile device.

44. The universal multi-vendor cross-platform system of claim 10, wherein the user profile is a shared user profile.

45. The universal multi-vendor cross-platform system of claim 44, wherein the shared user profile is associated with a shared QR code.

46. A universal multi-vendor cross-platform method for implementing cross-platform interactive guided user interfaces (GUIs), the universal multi-vendor cross-platform method comprising:
receiving, at a multi-vendor server, a first set of user interfaces and a first set of vendor information associated with a first vendor platform of a first vendor, the multi-vendor server communicatively coupled, via a computer network, to the first vendor platform;
receiving, at the multi-vendor server, a second set of user interfaces and a second set of vendor information associated with a second vendor platform of a second vendor, the multi-vendor server communicatively coupled, via the computer network, to the second vendor platform;
determining, via a cross-platform mobile application (app) implementing a cross-platform interactive GUI on a mobile device associated with a user, a current location or location setting of the mobile device, the mobile device comprising a data capture assembly, and the cross-platform mobile app communicatively coupled to the multi-vendor server via the computer network; and
determining, via the cross-platform mobile app, that that the current location or location setting of the mobile device is at, near, or associated with one of: (i) a first physical vendor location of the first vendor or (ii) a second physical vendor location of the second vendor,
wherein based on a determination of the current location or location setting being at, near, or associated with the first physical vendor location, the cross-platform mobile app receives the first set of user interfaces and the first set of vendor information, and renders, via a display of the mobile device, the cross-platform interactive GUI using the first set of user interfaces and the first set of vendor information, and
wherein, based on a determination of the current location or location setting being at, near, or associated with the second physical vendor location, the cross-platform mobile app receives the second set of user interfaces and the second set of vendor information, and renders, via the display of the mobile device, the cross-platform interactive GUI using the second set of user interfaces and the second set of vendor information.
